(19) United States
(12) Patent Application Publication
(10) Pub. No.: US 2006/0057291 A1
(43) Pub. Date: Mar. 16, 2006

(54) Printing and coating compositions comprising expandable polystyrene

(76) Inventors: Tibor Duris, Ludwigshafen (DE); Ralf Mobbach, Lindenberg (DE); Michael Riethues, Ludwigshafen (DE); Gunter Renz, Freinsheim (DE); Dieter Jacob, Cadolzburg (DE)

Correspondence Address: NOVAK DRUCE DELUCA & QUIGG, LLP, 1300 EYE STREET NW, SUITE 400 EAST, WASHINGTON, DC, 20005, US

(21) Appl. No.: 10/515,298

(22) PCT Filed: Jun. 4, 2003
(86) PCT No.: PCT/EP03/05844

§ 371 Date: Nov. 22, 2004

(30) Foreign Application Priority Data
Jun. 5, 2002 (DE) 10224984.9

(51) Int. Cl. B05D 3/02

(52) U.S. Cl. 427/372.2

(57) ABSTRACT

A process for generating raised textures on a substrate, in which a printing or coating composition comprising a film-forming polymeric binder, a solvent, heat-expandable polymer particles, and, where appropriate, other usual additives is applied to the substrate by printing or coating, and the printed or coated substrate is heat-treated, which comprises using expandable polymer particles which are colored or colorless expandable polystyrene beads whose diameter in the unexpanded state is from 0.1 to 5 mm.

The present invention relates to printing and coating compositions comprising expandable polystyrene, and also to a process for generating raised textures on a substrate.

It is known that heat-expandable polymer particles can be used in compositions for printing or coating, so as to generate raised textures on the printed or coated substrates.

U.S. Pat. No. 4,194,026 discloses a process for producing textured flexible foam coatings for acoustic walls and acoustic ceilings, by applying a crosslinkable, foamed elastomer emulsion, which comprises up to 20% by weight of heat-expandable polymer particles, uniformly to polyurethane foam components and heating the emulsion, whereupon the polymer particles expand and the elastomer emulsion dries and crosslinks to give a textured elastomeric coating.

JP 54137067 relates to the production of decorative materials by printing the materials with an ink which comprises foamable polymer particles. The particles are mixed with a binder, applied by printing, and foamed at around 150° C. Wallpapers are mentioned as materials to be printed.

JP 53115779 relates to coated polyurethane foams and their production. For this, an elastomer emulsion which comprises foamable polymer particles is spread on the polyurethane foam, and the foam is dried and heated. Foaming of the particles forms a textured surface.

JP 11105399 relates to foamable inks which comprise photoactive material and heat-expandable microcapsules, for producing foamed images. The ink is applied by screen printing and then exposed to light.

U.S. Pat. No. 4,006,273 discloses a process for producing a wash-resistant foamed print on a textile substrate, in which a printing composition comprising a film-forming, crosslinkable polymeric binder, a solvent, and from 1 to 45% by weight of thermoplastic, heat-expandable microcapsules with a diameter of from 0.5 to 300 μm is applied to the substrate, and the resultant coated substrate is dried and heated, giving a raised, textured surface. Polymeric materials mentioned for the heat-expanded microcapsules are polyvinylidene chloride, copolymers of vinylidene chloride and acrylonitrile, copolymers of acrylonitrile and methyl acrylate, and copolymers of methacrylonitrile and methyl acrylate.

It is an object of the present invention to provide further printing or coating compositions for textile printing and for textile coatings.

We have found that this object is achieved by means of a process for generating raised textures on a substrate, in which a printing or coating composition comprising a film-forming polymeric binder, heat-expandable polymer particles, and, where appropriate, other usual additives is applied to the substrate by printing or coating, and the printed or coated substrate is heat-treated, which comprises using expandable polymer particles which are colored or colorless expandable polystyrene beads whose diameter in the unexpanded state is from 0.1 to 5 mm.

Preferred expandable polystyrene particles are those whose diameter in the unexpanded state is from 0.4 to 2 mm. An example of their production is described in H. Gausepohl and R. Gellert (Editors), Polystyrol [Polystyrene], Becker/Braun Kunststoff Handbuch [Plastics Handbook], Hanser Verlag.

Polystyrene is readily available, inexpensive, and readily expandable.

The printing or coating compositions may be applied to the substrate by conventional textile printing processes, coating processes, or foam-coating processes.

Examples of suitable textile printing processes are flat-bed printing, rotary printing, and specialty printing processes.

Suitable coating compositions may be used in paste form or in foamed form, these being known as paste compounds or foam compounds. Examples of methods for applying these to the substrate are air-knife coating, doctor-and-slot coating, knife-over-blanket coating, rotary screens, transfer systems, face padding equipment, and a horizontal pad-mangle system. It is also possible to use suitable coating compositions in liquid form and spray these onto the substrate.

Suitable substrates are either textile or non-textile substrates.

Examples of textile substrates are wovens, knitteds, and nonwovens of any type, for example made from cotton, viscose, linen, wool, polyester, polyamide, acetate, triacetate, or from other synthetic fibers. Examples of non-textile substrates are paper, paperboard, leather, plastics, and wood.

Preferred substrates are textile substrates.

The printed or coated substrate is then subjected to heat treatment. During the heat treatment water evaporates and, where appropriate, the coating crosslinks, and the expandable polystyrene microbeads expand to give foam beads, forming a raised, textured surface on the textile substrate. The heat treatment is usually carried at from 70 to 140° C. for a period of from 20 s to 20 min. If the heat treatment is carried out at comparatively high temperature, for example from 120 to 200° C., the foamed polystyrene particles can melt, forming specks of molten polystyrene on the textile substrate.

The present invention also provides printing compositions for textile printing and coating compositions for foam coatings, comprising
a) from 1 to 99.9% by weight, preferably from 8 to 80% by weight, of an aqueous dispersion of a film-forming polymeric binder,
b) from 0.1 to 99% by weight, preferably from 5 to 25% by weight, of white or colored heat-expandable polystyrene particles whose diameter in the unexpanded state is from 0.1 to 5 mm,
c) from 0 to 98.9% by weight, preferably from 0 to 87% by weight, of added water, and
d) from 0 to 98.9% by weight, preferably from 0 to 20% by weight, of usual additives, such as antifoams, emulsifiers, thickeners, crosslinkers, colorants, pigment distributors, fillers, and fastness improvers.

Examples of usual aqueous dispersions of film-forming polymeric binders are aqueous dispersions of acrylate, of butadiene, of vinyl acetate, or of polyurethane, and aqueous dispersions of copolymers of these monomers. The solids content of the aqueous dispersions is preferably from 35 to 60% by weight. Besides the water already present in the aqueous dispersions used, the printing and coating compositions may comprise added water.

Examples of usual crosslinkers are urea-formaldehyde addition products and melamine-formaldehyde addition products. Other usual crosslinkers are polyisocyanates.

Examples of usual fastness improvers are silicone oils (polysiloxanes), such as Luprimol® SIG and Luprimol® SE.

Examples of usual colorants (dyes and pigments) are Helizarin® pigment preparations.

Suitable emulsifiers are non-ionic or anionic surfactants, such as Luprintol® PE New.

The printing and coating compositions of the invention permit three-dimensional structures to be generated on textile substrates. By using textile printing it is possible to apply the structures in decorative designs. It is possible here to use either uncolored or colored expandable polystyrene particles, or else to color the coating pastes or coating solutions. Various design effects can thus be achieved. Depending on the heat treatment used, the form in which the polystyrene particles are secured to the textile is either that of expanded foam beads or that of molten polystyrene specks. The wash-resistance of the prints and coatings is very good.

The present invention also provides the use of heat-expandable polystyrene particles whose diameter in the unexpanded state is from 0.1 to 5 mm as an additive to printing or coating compositions for textile substrates.

Preferred printing compositions A-J for textile printing are listed below by way of example.

A preferred composition A comprises
from 1 to 99.9% by weight, in particular from 4 to 90% by weight, of dispersions of acrylate, of butadiene, of vinyl acetate, or of polyurethane, their solids content being from 10 to 70% by weight, for example Helizarin® Binder TX 4574, as film-forming polymeric binder,
from 0.1 to 99% by weight, in particular from 5 to 25% by weight, of white or colored polystyrene particles whose particle size is from 0.1 to 5 mm, for example Styropor® P656,
from 0 to 98.9% by weight, in particular from 0 to 87% by weight, of added water,
from 0 to 1% by weight of silicone-free or silicone-containing antifoams,
from 0 to 6% by weight, in particular from 0.5 to 4.5% by weight, of a mixture of non-ionic surfactants, methoxylated melamine, and silicone oil, for example Luprintol® MCL, as emulsifier compound, and
from 0 to 6% by weight, in particular from 0 to 4.5% by weight, of polyacrylates, for example Lutexal® HIT, as thickeners.

A further preferred composition B comprises
from 1 to 99.9% by weight, in particular from 8 to 80% by weight, of dispersions of acrylate, of butadiene, of vinyl acetate, or of polyurethane, for example Helizarin® Binder TX 4574, as film-forming polymeric binder,
from 0.1 to 99% by weight, in particular from 5 to 25% by weight, of white or colored polystyrene particles whose particle size is from 0.1 to 5 mm, for example Styropor® P656,
from 0 to 98.8% by weight, in particular from 0 to 87% by weight, of added water, from 0 to 1% by weight of silicone-free or silicone-containing antifoams,
from 0.1 to 2% by weight, in particular from 0.3 to 1.5% by weight, of non-ionic or anionic surfactants, such as Luprintol® PE New, as emulsifier,
from 0to 4% by weight, in particular from 0 to 2.5% by weight, of urea-formaldehyde addition products or melamine-formaldehyde addition products, for example Helizarin® fixer LF, as crosslinkers,
from 0 to 3% by weight, in particular from 0 to 1.5% by weight, of polysiloxane, such as Luprimol® SE, as fastness improvers,
from 0 to 6% by weight, in particular from 0 to 4.5% by weight, of polyacrylates, for example Lutexal® HIT, as thickeners.

A further preferred composition C comprises
from 1 to 99.9% by weight, in particular from 8 to 80% by weight, of dispersions of acrylate, of butadiene, of vinyl acetate, or of polyurethane, for example Helizarin® Binder TX 4574, as film-forming polymeric binder,
from 0.1 to 99% by weight, in particular from 5 to 25% by weight, of white or colored polystyrene particles whose particle size is from 0.1 to 5 mm, for example Styropor® P656,
from 0 to 98.9% by weight, in particular from 0 to 87% by weight, of added water, from 0 to 1% by weight of silicone-free or silicone-containing antifoams,
from 0 to 6% by weight, in particular from 0.5 to 4.5% by weight, of a mixture of non-ionic surfactants, methoxylated melamine, and silicone oil, for example Luprintol®MCL, as emulsifier compound, and
from 0 to 3% by weight, in particular from 0 to 1.5% by weight, of polysiloxanes, such as Luprimol® SE, as fastness improvers,
from 0 to 10% by weight, in particular from 0 to 8.5% by weight, of polyisocyanates, such as Astazin® hardener CN, as crosslinkers,
from 0 to 6% by weight, in particular from 0 to 4.5% by weight, of polyacrylates, for example Lutexal® HIT, as thickeners.

A further preferred composition D comprises
from 1 to 99.9% by weight, in particular from 8 to 80% by weight, of dispersions of acrylate, of butadiene, of vinyl acetate, or of polyurethane, for example Helizarin® Binder TX 4574, as film-forming polymeric binder,
from 0.1 to 99% by weight, in particular from 5 to 25% by weight, of white or colored polystyrene particles whose particle size is from 0.1 to 5 mm, preferably Styropor® P656,
from 0 to 98.9% by weight, in particular from 0 to 87% by weight, of added water,
from 0 to 1% by weight of silicone-free or silicone-containing antifoams,
from 0 to 2% by weight, in particular from 0.3 to 1.5% by weight, of non-ionic or anionic surfactants, for example Luprintol® PE New, as emulsifier,
from 0 to 3% by weight, in particular from 0 to 1.5% by weight, of polysiloxanes, such as, Luprimol® SE, as fastness improvers,
from 0 to 10% by weight, in particular from 0 to 8.5% by weight, of polyisocyanates, such as Astazin® hardener CN, as crosslinker,
from 0 to 6% by weight, in particular from 0 to 4.5% by weight, of polyacrylates, for example Lutexal® HIT, as thickeners.

A further preferred composition E comprises
from 1 to 99.9% by weight, in particular from 8 to 80% by weight, of dispersions of acrylate, of butadiene, of vinyl acetate, or of polyurethane, for example Helizarin® Binder TX 4574, as film-forming polymeric binder,
from 0.1 to 99% by weight, in particular from 5 to 25% by weight, of white or colored polystyrene particles whose particle size is from 0.1 to 5 mm, preferably Styropor® P656,
from 0 to 98.9% by weight, in particular from 0 to 87% by weight, of added water,
from 0 to 1% by weight of silicone-free or silicone-containing antifoams,
from 0 to 6% by weight, in particular from 0.5 to 4.5% by weight, of a mixture of non-ionic surfactants, methoxylated melamine, and silicone oil, for example Luprintol® MCL, as emulsifier compound, and
from 0 to 70% by weight, in particular from 0 to 10% by weight, of pigment preparation, such as Helizarin® pigment,
from 0 to 6% by weight, in particular from 0 to 4.5% by weight, of polyacrylates, for example Lutexal® HIT, as thickeners.

A further preferred composition F comprises
from 1 to 99.9% by weight, in particular from 8 to 80% by weight, of dispersions of acrylate, of butadiene, of vinyl acetate, or of polyurethane, for example Helizarin® Binder TX 4574, as film-forming polymeric binder,
from 0.1 to 99% by weight, in particular from 0 to 87% by weight, of white or colored polystyrene particles whose particle size is from 0.1 to 5 mm, for example Styropor® P656,
from 0 to 98.9% by weight, preferably from 0 to 87% by weight, of added water,
from 0 to 1% by weight of silicone-free or silicone-containing antifoams,
from 0 to 2% by weight, in particular from 0.3 to 1.5% by weight, of non-ionic or anionic surfactants, for example Luprintol® PE New, as emulsifier,
from 0 to 4% by weight, in particular from 0 to 2.5% by weight, of urea-formaldehyde addition products or melamine-formaldehyde addition products, for example Helizarin® fixer LF, as crosslinkers,
from 0 to 3% by weight, in particular from 0 to 1.5% by weight, of polysiloxanes, such as Luprimol® SE, as fastness improvers,
from 0 to 70% by weight, in particular from 0 to 10% by weight, of pigment preparation, such as Helizarin® pigment,
from 0 to 6% by weight, in particular from 0 to 4.5% by weight, of polyacrylates, for example Lutexal® HIT, as thickeners.

A further preferred composition G comprises
from 1 to 99% by weight, in particular from 8 to 80% by weight, of dispersions of acrylate, of butadiene, of vinyl acetate, or of polyurethane, for example Helizarin® Binder TX 4574, as film-forming polymeric binder,
from 0.1 to 99% by weight, in particular from 5 to 25% by weight, of white or colored polystyrene particles whose particle size is from 0.1 to 5 mm, for example Styropor® P656,
from 0 to 98.9% by weight, in particular from 0 to 87% by weight, of added water,
from 0 to 1% by weight of silicone-free or silicone-containing antifoams,
from 0 to 6% by weight, in particular from 0.5 to 4.5% by weight, of a mixture of non-ionic surfactants, methoxylated melamine, and silicone oil, for example Luprintol® MCL, as emulsifier compound,
from 0 to 3% by weight, in particular from 0 to 1.5% by weight, of polysiloxanes, such as Luprimol® SE, as fastness improvers,
from 0 to 10% by weight, in particular from 0 to 8.5% by weight, of polyisocyanates, such as Astazin® hardener CN, as crosslinkers,
from 0 to 70% by weight, in particular from 0 to 10% by weight, of pigment preparation, such as Helizarin® pigment,
from 0 to 6% by weight, in particular from 0 to 4.5% by weight, of polyacrylates, for example Lutexal® HIT, as thickeners.

A further preferred composition H comprises
from 1 to 99.9% by weight, in particular from 8 to 80% by weight, of dispersions of acrylate, of butadiene, of vinyl acetate, or of polyurethane, for example Helizarin® Binder TX 4574, as film-forming polymeric binder,
from 0.1 to 99% by weight, in particular from 5 to 25% by weight, of white or colored polystyrene particles whose particle size is from 0.1 to 5 mm, for example Styropor® P656,
from 0 to 98.9% by weight, in particular from 0 to 87% by weight, of added water,
from 0 to 1% by weight of silicone-free or silicone-containing antifoams,
from 0.1 to 2% by weight, in particular from 0.3 to 1.5% by weight, of non-ionic or anionic surfactants, for example Luprimol® PE New, as emulsifier,
from 0 to 3% by weight, in particular from 0.3 to 1.5% by weight, of polysiloxanes, such as Luprimol® SE as fastness improvers,
from 0 to 10% by weight, in particular from 0 to 8.5% by weight, of polyisocyanates, such as Astazin® hardener CN, as crosslinkers,
from 0 to 70% by weight, in particular from 0 to 10% by weight, of pigment preparation, such as Helizarin® pigment,
from 0 to 6% by weight, in particular from 0 to 4.5% by weight, of polyacrylates, for example Lutexal® HIT, as thickeners.

Preferred coating compositions I and J for foam coating are listed below by way of example.

A preferred composition I comprises
from 1 to 99.9% by weight, in particular from 8 to 80% by weight, of dispersions of acrylate, of butadiene, of vinyl acetate, or of polyurethane, for example Helizarin® Binder TX 4624 or 4574, as film-forming polymeric binder,
from 0.1 to 99% by weight, in particular from 5 to 25% by weight, of white or colored polystyrene particles whose particle size is from 0.1 to 5 mm, for example Styropor® P656,
from 0 to 98.9% by weight, in particular from 0 to 87% by weight, of added water,
from 0 to 1% by weight, in particular from 0 to 0.5% by weight, of 25% strength by weight aqueous ammonia,
from 0 to 2% by weight, in particular from 0 to 1% by weight, of urea-formaldehyde addition product or melamine-formaldehyde addition product, for example Saduren® 163, as crosslinker,
from 0 to 1% by weight, in particular from 0 to 0.5% by weight, of polyphosphate, sodium polyacrylate or ammonium polyacrylate, for example Pigmentverteiler® A, as dispersing agent,
from 0 to 30% by weight, in particular from 0 to 15% by weight, of magnesium silicate or aluminum silicate, for example Talkum® IT Star 20, as filler,
from 0 to 5% by weight, in particular from 0 to 3% by weight, of fatty ester, potassium stearate, or ammonium stearate, for example C&S-Stabsol®, as foam stabilizer,
from 0 to 30% by weight of polyacrylates, such as Latekoll® D or Lutexal HIT, as thickeners.

The pH of composition I is preferably from 9 to 9.5. Its viscosity is preferably in the range from 20 to 45 dPa×s, measured using a Haake VT02, spindle 1.

Another preferred composition J comprises
from 1 to 99.9% by weight, in particular from 8 to 80% by weight, of dispersions of acrylate, of butadiene, of vinyl acetate, or of polyurethane, for example Helizarin® Binder TX 4624 or 4574, as film-forming polymeric binder,
from 0.1 to 99% by weight, in particular from 5 to 25% by weight, of white or colored polystyrene particles whose particle size is from 0.1 to 5 mm, for example Styropor® P656,
from 0 to 98.9% by weight, in particular from 0 to 87% by weight, of water, from 0 to 1% by weight, in particular from 0 to 0.5% by weight, of 25% strength by weight aqueous ammonia,
from 0 to 2% by weight, in particular from 0 to 1% by weight, of urea-formaldehyde addition product or melamine-formaldehyde addition product, for example Saduren® 163, as crosslinker,
from 0 to 1% by weight, in particular from 0 to 0.5% by weight, of polyphosphate, sodium polyacrylate or ammonium polyacrylate, for example Pigmentverteiler® A, as dispersing agent,
from 0 to 30% by weight, in particular from 0 to 15% by weight, of magnesium silicate or aluminum silicate, for example Talkum® IT Star 20, as filler,
from 0 to 70% by weight, in particular from 0 to 10% by weight, of pigment preparation, such as Helizarin®,
from 0 to 5% by weight, in particular from 0 to 3% by weight, of fatty ester, potassium stearate, or ammonium stearate, for example C&S-Stabsol®, as foam stabilizer,
from 0 to 30% by weight of polyacrylates, such as Latekoll® D, as thickeners.

The pH of composition J is preferably from 9 to 9.5. Its viscosity is preferably in the range from 20 to 45 dPa×s, measuring using a Haake VT02, spindle 1, and its foam density is preferably in the range from 200 to 600 g/l. Composition J is preferably applied by a doctor system and dried for example at 100° C. and expanded for about 1 min at 130° C.

The present invention also provides the use of the printing and coating compositions for printing or coating textile substrates.

1. A process for generating raised textures on a textile substrate, in which a printing or coating composition comprising a film-forming polymeric binder, a solvent, heat-expandable polymer particles, and, where appropriate, other usual additives is applied to the substrate by printing or coating, and the printed or coated textile substrate is heat-treated, whereby the expandable polymer beads expand to give foam beads, forming a raised, textured surface on the textile substrate, which comprises using expandable polymer particles which are colored or colorless expandable polystyrene microbeads whose diameter in the unexpanded state is from 0.1 to 5 mm.

2. The process as claimed in claim 1, wherein the printing or coating compositions comprises
a) from 1 to 99.9% by weight of an aqueous dispersion of a film-forming polymeric binder,
b) from 0.1 to 99% by weight of heat-expandable polystyrene particles whose diameter in the unexpanded state is from 0.1 to 5 mm,
c) from 0 to 98.9% by weight of added water, and
d) from 0 to 98.9% by weight of usual additives, such as antifoams, emulsifiers, thickeners, crosslinkers, colorants, pigment dispersers, dispersing agents, and fillers.

3. The process as claimed in claim 2, wherein the aqueous dispersion of the film-forming polymeric binder is an aqueous dispersion of acrylate, of butadiene, of vinyl acetate, or of polyurethane, or is an aqueous dispersion of copolymers of the monomers mentioned.
